(19) United States
(12) Patent Application Publication
(10) Pub. No.: US 2004/0192313 A1
(43) Pub. Date: Sep. 30, 2004

(54) Method for cell selection and reselection by a cellular mobile station in idle mode

(75) Inventor: Marcia Jean Otting, Mundelein, IL (US)

Correspondence Address: BRINKS HOFER GILSON & LIONE, P.O. BOX 10395, CHICAGO, IL, 60610, US

(73) Assignee: Motorola, Inc.

(21) Appl. No.: 10/396,523

(22) Filed: Mar. 25, 2003

(51) Int. Cl. H04Q 7/20

(52) U.S. Cl. 455/446; 455/450

(57) ABSTRACT

A method for permitting mobile stations in idle mode to select a cell based on services provided by the cell. Network control of service based selection is regulated by a new broadcast parameter broadcasting whether a particular cell will allow service based cell selection.

The present invention relates to a cellular mobile station's selection and reselection of a cell while the mobile station is in idle mode, and more particularly to a method for permitting the mobile station to select and reselect a cell on the basis of the availability of services.

### BACKGROUND

Communication systems are well known and consist of many types, including land mobile radio, cellular radiotelephone, personal communication systems, and other communication system types. Within a communication system, transmissions are conducted between a transmitting device and a receiving device over a communication resource, commonly referred to as a communication channel. Typically, transmissions have consisted of encoded voice signals.

The Global System for Mobile Communications Standards (GSM) 3.22, incorporated by reference herein, gives an overview of the tasks undertaken by a GSM mobile station (also referred to as an “MS”) while in idle mode, that is, when the mobile station is switched on but not having a dedicated channel allocated, e.g., not making or receiving a call.

When a mobile station is switched on, it attempts to make contact with a GSM public land mobile network (PLMN). The particular PLMN to be contacted may be selected either automatically or manually. The mobile station looks for a suitable cell of the chosen PLMN and chooses that cell to provide available services and tunes to that cell's control channel. This choosing is referred to as “camping on a cell.” The mobile station then registers its presence in the location area of the chosen cell, if necessary.

If the mobile station loses coverage of a cell, it reselects to the most suitable alternative cell of the selected PLMN and camps onto that cell. If the new cell is in a different location area, location area update is again performed. If the mobile station loses coverage of a PLMN, either a new PLMN is selected automatically, or an indication of which PLMNs are available is displayed to the user so that manual selection can be made.

Under the present standards, cell selection and reselection by a mobile station while in idle mode of a suitable cell is based primarily on the signal strength of a given cell. Initially, the mobile station looks for a cell that satisfies certain criteria by checking cells in descending order of signal strength. If a suitable cell is found, the mobile station camps on it and performs whatever registration within the PLMN is necessary. When camped on a cell the mobile station regularly looks to see if there is a better cell in terms of a cell re-selection criterion and, if there is, the better cell is selected.

The current cell monitoring process in GSM/GPRS (Global System for Mobile Communications/General Packet Radio Services) is described in detail in GSM recommendation 5.08, incorporated by reference herein. As described, the mobile station monitors available cells and reports measurements for a subset of those cells having the best signal quality. Thus, mobiles are allowed only to select a cell based on signal strength and availability.

More recently, cells have begun to carry other forms of signals, including high-speed packetized data signals. Additional services available to the mobile station user include the ability to provide a video call, the ability to provide a data call, the ability to provide a bounded transfer delay, and the ability to provide a specified data throughput, or any combination thereof. One such communication system is the General Packet Radio Service (GPRS) system as described in the Global System for Mobile Communications (GSM) Technical Specification (TS) 2.60, which is incorporated by reference herein. The GPRS system offers a wireless Wide Area Network (WAN) supporting a wide range of applications, such as low-volume intermittent telemetry, video, web browsing, and the transfer of large amounts of data.

At present, some cells within a PLMN support GPRS and others do not, and current methods for selection and reselection of a suitable cell during idle mode do not allow selection or reselection of a cell by the mobile station based on the availability of such services. Thus, a customer desiring such services will be denied selecting or reselecting a GPRS cell if another cell in the PLMN is more suitable, primarily defined by signal strength of the cell, according to current GSM parameters for the selection and reselection of cells.

One proposed solution is simply to allow the mobile station to always favor GPRS cells for selection and reselection regardless of whether there is a “better” cell according to the current parameters for selection and reselection. This has been opposed by network operators for the reason that allowing mobiles to favor GPRS cells for selection and reselection may disrupt network and cell planning by permitting mobiles to select and reselect weak cells, merely to obtain GPRS services, thereby affecting network performance. For instance, by permitting mobiles to select and reselect cells based on service availability, regardless of the strength of the cell, mobile stations selecting preferentially on the availability of services will hang on to such cell despite the weakness of the signal. This may result in the overloading of such cells by mobile stations.

Katz, U.S. Pat. No. 6,119,021 has proposed adding a GPRS_Supported parameter to the previous parameters of CELL_BAR_ACCESS and CELL_BAR_QUALIFY. According to Katz, the network operator can control the setting of the parameter. Thus, when the network determines that certain cells are overloaded or requires control of the network for some other reason, the bit can be switched. However, this means that GPRS, or other available services, is entirely switched off the cell, thereby barring access to the service to all mobile stations, even those for whom the cell is the most suitable cell according to current standards. In other words, either everybody or nobody gets the additional services.

The present invention attempts to overcome the limitations of the present system by permitting the mobile station to select or reselect a cell based on the availability of services and provides the network operators control over the mobile station's ability to select and reselect cells based on the availability of other services, without denying all mobile stations desiring such services access to the those services.

### BRIEF DESCRIPTION OF THE DRAWINGS

FIG. 1 shows the structure of a cellular mobile radio system in accordance with one embodiment of the present invention.

FIG. 2 is a flow diagram of an embodiment according to the present invention.

FIG. 3 is a flow diagram of an embodiment according to the present invention.

FIG. 4 is a block diagram of an exemplary radiotelephone system.

### DETAILED DESCRIPTION OF THE PRESENTLY PREFERRED EMBODIMENTS

The present invention is directed to methods and apparatus for permitting a mobile station to select and reselect a suitable cell upon which to camp during idle mode based on the availability of desired services, such as GPRS. In accordance with one embodiment, a new parameter is broadcast that identifies whether a mobile station is permitted to preferentially select/reselect a cell based on the availability of certain services. To control and maintain network performance, the network operators may switch between permitting such preferential selection and normal selection based on signal strength. In this manner, the overloading of certain service providing cells is avoided while still permitting access to such services from the cells. Thus, the customer can set his mobile station to preferentially select for services while at the same time, the network can control its network performance.

The new parameter has two settings: 1) GPRS service-based selection and reselection is allowed; and 2) GPRS service-based selection and reselection is not allowed. Thus, for example, the network operator can permit preferential selection and reselection by a mobile station onto GPRS, or other service providing cells, even when a stronger cell (in terms of signal quality) without GPRS, is available, but then switch to barring that option when cell overloading is affecting network performance. When the selection/reselection parameter is barred on a particular cell, though mobile stations remote to that cell will not have access to GPRS services (or other available services) from that cell, mobile stations which are nearer to the cell may still be able to obtain such services as long as the cell providing that service is the mobile station's best in accordance with current standards for selection/reselection. In other words, a mobile station whose best cell is a GPRS cell may still have access to GPRS, while others do not, but selection and reselection are still determined by traditional selection/reselection parameters, i.e., signal strength.

In general a radio communication system includes a plurality of service areas. Each service area, or cell, defines a geographic area that is provided with services by one or more associated based stations. Each base station is configured for radio communication with one or more mobile stations. The network controller controls the operation of the communication system.

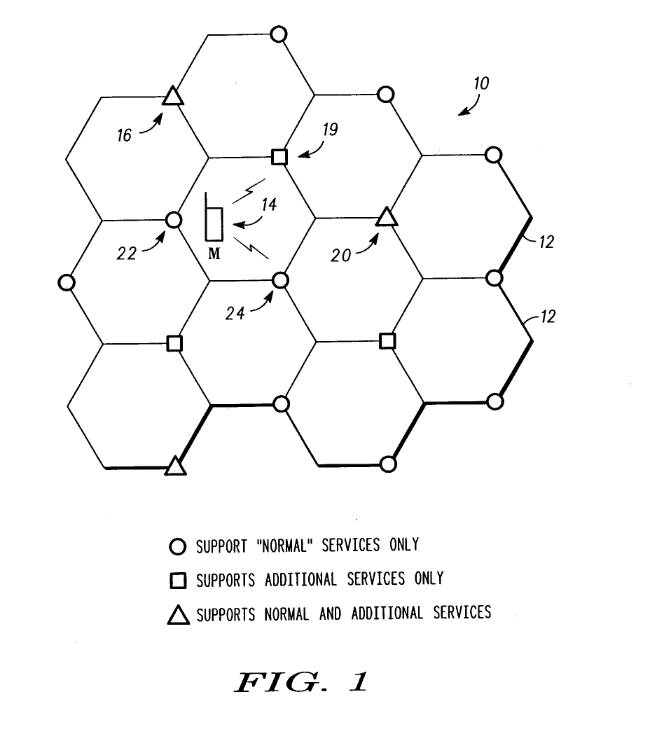

FIG. 1 is an illustration of communication system 10, including a plurality of hexagonal radio cells 12, mobile station 14, and base stations 16, 18, 20, 22 and 24. For illustration, the cells are shown as hexagonal, however, any shape may be used. Within communication system 10, the service areas, or cells, are arranged according to a cell re-use pattern to permit re-use of radio frequencies or channels. This promotes efficient use of radio channels and limits co-channel interference, as is well known in the art.

Each base station regularly sends out system information over a broadcast channel (BCCH), which is received and evaluated by the mobile station while in idle mode. Information includes the parameters CELL_BAR_ACCESS and CELL_BAR_QUALIFY. These parameters describe whether access to a cell can be had and with what priority. The Cell_Bar Control File which contains the parameters CELL_BAR_ACCESS and CELL_BAR_QUALIFY determines the function of the cell or of the base station supplying the cell. If, for instance, the base station is blocked by setting the parameter CELL_BAR_ACCESS and, in addition, the parameter CELL_BAR_QUALIFY is set, then the cell is actually blocked for access to the mobile stations, but can, in principle, if no other “free” cell is present permit as a last opportunity access to a mobile station. By the CELL_BAR_QUALIFY parameter, therefore, a low access priority is indicated compared with the mobile station. This is a cell having a Lower-Priority-Access.

The parameter CELL_BAR_ACCESS expresses whether a cell is open or blocked. For example, there are mobile stations that support GSM-phase one and GSM-phase 2. A GSM-phase one mobile station sees only the parameter CELL_BAR_ACCESS and thus knows whether or not the cell is open. If it is not, then the GSM-phase one mobile station cannot be camped at all on this cell. A GSM phase two mobile station also sees the parameter CELL_BAR_QUALIFY, and recognizes at first, on the basis of CELL_BAR_ACCESS, that the cell is blocked, but also recognizes that access can be had to this cell. The mobile station must first, however, determine whether other more suitable cells can be reached before a cell of lower priority can be used. Further parameters that may be broadcast include the parameter GPRS_Supported and other services that may come into existence in the future.

The PLMN operator may decide not to allow mobile stations to camp on certain cells. These cells, for example, may only be used for hand over traffic, i.e., calls in progress that need to be handed over to other cells. Others many be barred for other reasons. As such, barred cell information is broadcast as system information to instruct mobile stations not to camp on these cells. The barred cells status may change dynamically and, thus, the mobile station must regularly monitor the system information for this parameter.

For normal service, the mobile station has to camp onto a suitable cell, as defined by GSM standards, tune to that cell's control channel, and possibly register. The choice of a suitable cell for the purpose of receiving normal service is referred to as “normal camping.”

Through algorithms implemented in the mobile station, the mobile station is able to choose the best cell on which to initiate a request for service while the mobile station is in idle mode (initial cell selection). Once a request for service is accepted, additional algorithms are employed to monitor the best cell on which to continue service as the mobile station moves with the service area. Existing parameters define the minimum criteria for cell selection and reselection in idle mode.

The mobile station uses the “path loss criterion” parameter C1 (GSM 05.05 at 6.4, incorporated by reference herein) to determine whether a cell is suitable to camp on. C1 depends on four parameters i) the received signal level (suitably average); ii) the parameter RXLEV_ACCESS_MIN, which is broadcast system information, and is related to the minimum signal that the operator wants the network to receive when being initially accessed by an mobile station; iii) the parameter MS_TXPWER_MAX_CCH, which is also broadcast as system information, and is the maximum power that an mobile station may use when initially accessing the network; and iv) the maximum power of the mobile station. The formula for determining C1 is given in GSM 05.08 (6.4), incorporated by reference herein.

The mobile station searches all channels within its bands of operation, takes readings of received radio frequency (RF) signal level on each channel and calculates the “received level averages” (RLS_C). The mobile station maintains a running average of received signal level (RLA_C) measurements from the top six cells. Thus, while camped on a cell, the mobile station regularly looks to see if there is a better cell in terms of re-selection criterion, and if there is, the better cell is selected. Also, if one of the other criteria changes (e.g., the current serving cell becomes barred), or there is a downlink signaling failure, a new cell is selected. This is referred to as cell reselection.

In order to optimize cell reselection, additional cell reselection parameters can be broadcast as system information of each cell. The cell reselection process employs a parameter C2. The parameters used to calculate C2 include i) CELL_RESELECT_OFFSET; ii) PENALTY_TIME (when the mobile station places the cell on the list of the strongest carriers as specified in GSM 05.08 (6.4), incorporated by reference herein, its starts a time which expires after the PENALTY_TIME); iii) TEMPORARY_OFFSET. The permitted values of these parameters and the way in which they are combined to calculate C2 are defined in GSM 05.08 (6.4). Instead of the parameter C2, a GPRS mobile station applies the corresponding parameter if provided. A mobile station supporting SoLSA (local service area subscription) with SolSA subscription uses the SoLSA cell reselection parameters (GSM 05.08 (6.6.3), incorporated by reference herein).

At present, however, not every cell supports additional services such as GPRS. For example, as shown in FIG. 1, base station 18, depicted by a square, supports only “additional” services, base stations 22 and 24, depicted by circles, support “normal” services only, base stations 16 and 20, depicted by triangles, support normal plus additional services such GPRS. The system information sent out by base stations 22 and 24 contains no GPRS_supported parameter, whereas base stations 16 and 20 support both “normal” and additional, such as GPRS services. The parameters broadcast for these cells 16 and 20, includes CELL_BAR_ACCESS, CELL_BAR_QUALIFY, and GPRS_SUPPORTED. A mobile station desiring GPRS services would be permitted to camp onto cells 16 or 20 and receive GPRS services to the extent that one of these cells was the “best” cell as defined by current standards.

Presently, the availability of services has not been part of the selection criteria. Although addition of the parameter GPRS_SUPPORTED (or other service) is available, the service is either made available on a cell or it is not available on a cell for all mobile stations.

In accordance with the present invention, when a mobile station desiring GPRS services camps on a cell not supporting GPRS services, because the “best” cell based on normal criteria does not support GPRS, the mobile station triggers a “GPRS preferred service based selection/reselection mode.” This can be accomplished automatically or manually upon camping on a cell not supporting GPRS services or it can be set by the mobile station owner at any time. Thus, by changing its prioritization of cells from signal strength to that of service availability, the mobile station can receive information about which cells support such selection/reselection and prioritize calls on that basis.

In this state, the mobile station continues to monitor cells for signal quality but also monitors for service based selection/reselection capability, but prioritizes cells of suitable signal quality first by availability of services, followed by prioritization by signal strength. For example, if GPRS services are desired, the first criteria for choosing the cell to be camped on is whether such services are available followed by the usual criteria for cell selection and reselection. However, the network controls such service based selection by broadcasting whether such preferential selection will be allowed.

Thus, according to one embodiment of the present invention, the system information sent out by base stations 16 and 20 includes an additional parameter with the value GPRS SELECTION/RESELECTION_ALLOWED or GPRS SELECTION/RESELECTION_NOTALLOWED that may be broadcast. Thus, in addition to broadcasting that GPRS services are available, these parameters permit a mobile station preferentially desiring GPRS services to selectively camp onto a GPRS supported cell allowing for such preferential selection regardless of the availability of a cell (which may or may not be GPRS supported) with greater signal strength.

If the network operator discovers problems in mobile stations camping on cells simply because of their services, rather than turning off the desired services completely (thereby denying access to all mobile stations) as previously suggested, the GPRS SELECTION/RESELECTION_NOTALLOWED bit is set thereby clearing the cell of remote mobile stations but permitting closer mobile stations to obtain the desired services (dependent, of course, on signal quality). In other words, mobile stations that can still consider the GPRS or other service supported cell their “best cell” in terms of signal quality will still have access to the cell and the desired service, while distant or remote mobile stations will not.

Thus, according to one embodiment of the present invention, depending on the state of the bits, i.e., whether the bit is set or not, the cell signal may indicate whether the cell is open or blocked, whether the cell is GPRS (or other service supported), and whether or not the mobile station can preferentially select that cell based on GPRS or other service.

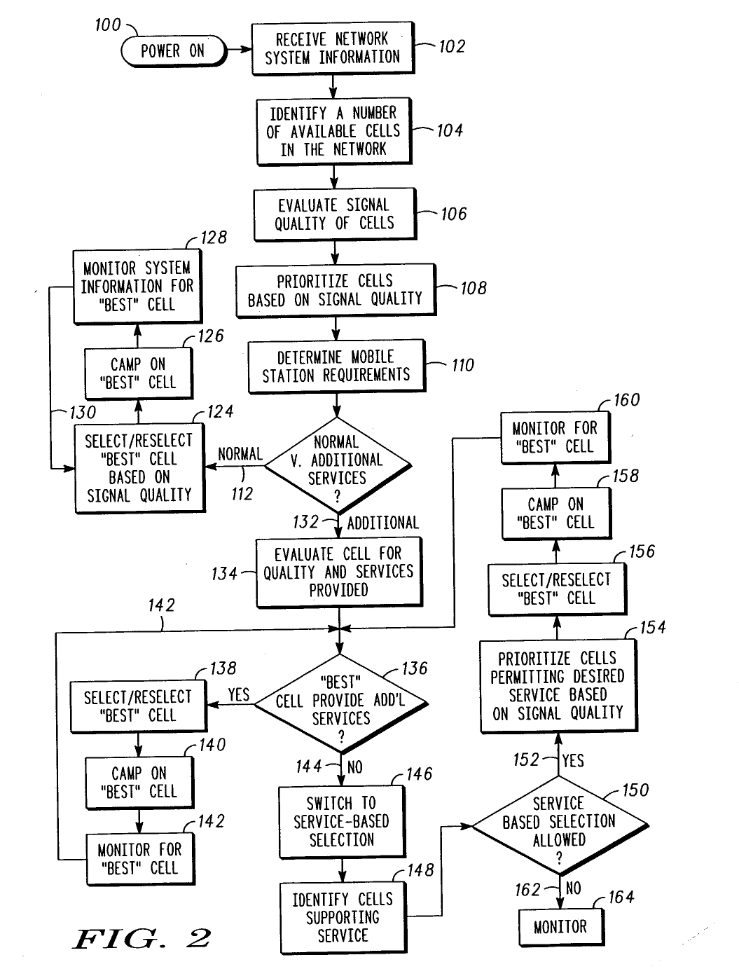

Cell selection and reselection according to one embodiment of the present invention is illustrated in the flow diagram of FIG. 2. During typical operation, a mobile station is powered on, block 100, and receives broadcast information, i.e. the network system information, block 102. The network information includes information about cells that presently are not providing services, those providing only normal services, those providing only additional services, and those providing both normal and additional services.

A number of available cells in the network are identified, block 104, and the cell quality of each cell is evaluated based on the standards for cell selection based in GSM 3.22, incorporated by reference herein, block 106. Cells are prioritized according to the “path loss criterion” (C1), block 108, primarily based on signal strength. The requirements of the mobile station are identified, block 110. A mobile station requiring only normal services, block 112, selects the “best” cell based on signal quality, block 124, and camps, block 126, on that cell. As the mobile station moves through the service area, it monitors the system information to determine if a better cell becomes available, block 128. If a better cell becomes available, the mobile station reselects that cell and proceeds to camp on that cell, arrow 130.

If additional services 132, such as GPRS services are required by the mobile station, the mobile station proceeds to evaluate cells for services and signal quality, block 134. If the best cell provides the additional services, block 136, that cell is selected, block 138, and camped on, block 140. As with normal services, the mobile station continues to monitor the network information, block 142, for a better cell according to standard criterion for cell reselection. According to the present invention if the most “suitable cell” (highest signal) does not support additional services, 144, the mobile station, after receiving no service available for GRPS or other desired services, switches, either automatically or manually, to service-based selection/reselection, block 146. Cells supporting the requested service are identified as supporting the service, block 148. An additional parameter is broadcast indicating whether service based selection is allowed at that time, block 150. If service-based selection is allowed 152, the mobile station selects the best cell, block 156, from a list of prioritized cells allowing for such selection, block 154, and camps on that cell, block 158. As with normal selection procedures, the mobile station continues to monitor the network information for a better cell, block 160, testing each choice of a better cell to see if it supports the desired services (block 136).

In accordance with an embodiment of the present invention, the mobile station receives broadcast information from cells supporting the additional services and whether those cells permit the selection/reselection of those cells on the basis of service preference (e.g. GPRS SELECTION/RESELECTION_ALLOWED). Thus, cells broadcasting the GPRS SELECTION/RESELECTION_ALLOWED parameter are then listed first and then prioritized according to signal strength. Cells not permitting selection/reselection based on availability of additional services, such as GPRS, broadcast the parameter GPRS SELECTION/RESELECTION_NOTALLOWED.

If overloading of a cell occurs, the network can change the service-based selection parameter to service-based selection not allowed for a particular cell thereby barring mobile stations from selecting or reselecting that cell based on services 162. In this case the mobile station can continue to monitor 164 until such selection is available or the mobile station can revert from selection/reselection on the basis of service mode to selection/reselection based on the normal parameters, block 138.

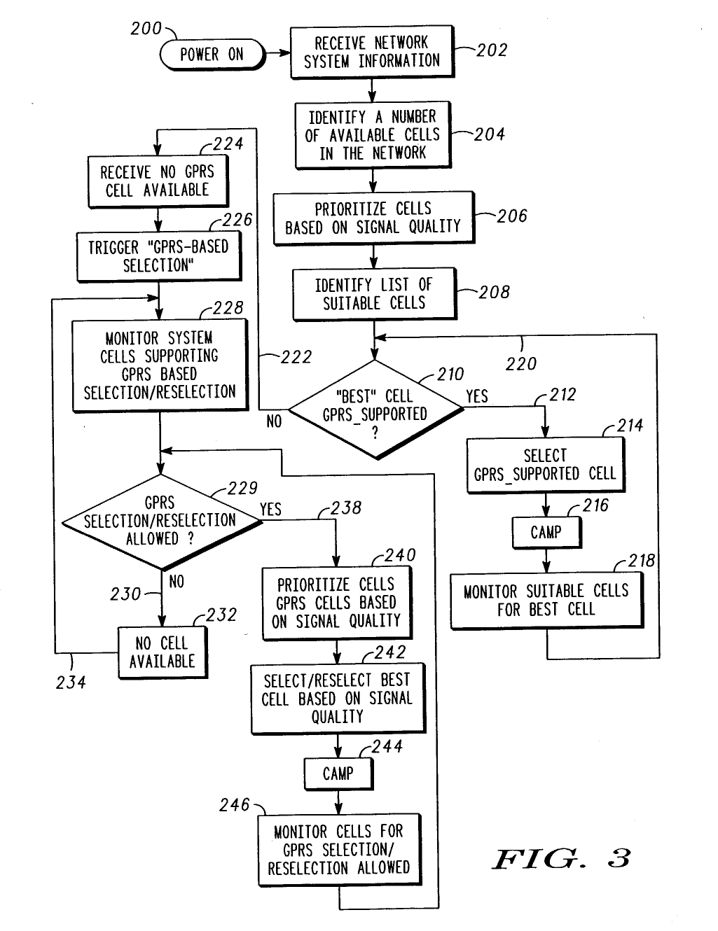

FIG. 3 illustrates another embodiment of the cell selection/reselection method of the present invention.

The mobile station is powered on, block 200, and begins receiving network information 202. A number of cells are identified in the network, block 204, and prioritized according to the standard parameters, block 206. The list of suitable cells, as defined by current standards, is identified, block 208, and the mobile station determines whether the “best cell” is GPRS or other service supported, block 210. If it is, 212, the mobile station selects that cell, block 214, camps on it, block 216, and continues to monitor cells as the mobile station moves through the service area for a better cell, block 218. As the mobile station moves through the service area and the “best” cell under the normal standards changes, the mobile station receives information as to whether the-new cell supports the desired services, 220.

If either during initial selection or later reselection the “best cell” identified by normal parameters does not support GPRS, 222, the mobile station considers this “no cell available,” block 224. The mobile station can be either manually or automatically switched to GPRS-based selection, block 226. In the preferred embodiment, the mobile station, upon receiving the no cell available signal, will automatically trigger the GPRS-based selection/reselection mode. The system is monitored for cells providing GPRS and which allow selection/reselection based on the availability of GPRS, block 228. If GPRS-based selection is not allowed, 230, the mobile station considers this “no cell available,” block 232, and the mobile station continues to the monitor the system for service based selection/reselection, 234.

If service based selection and reselection is allowed, 238, the cells allowing such selection are then prioritized according to normal parameters, block 240, and the best cell (based on cell quality) from the cells permitting GPRS-based selection is selected, block 242, camped on, block 244. The mobile station continues to monitor cells first for GPRS-based selection/reselection allowed and then signal quality, block 246 and arrow 247. In this embodiment, if a cell with the desired services does not become available, the mobile station can switch back to selection/reselection based on normal parameters.

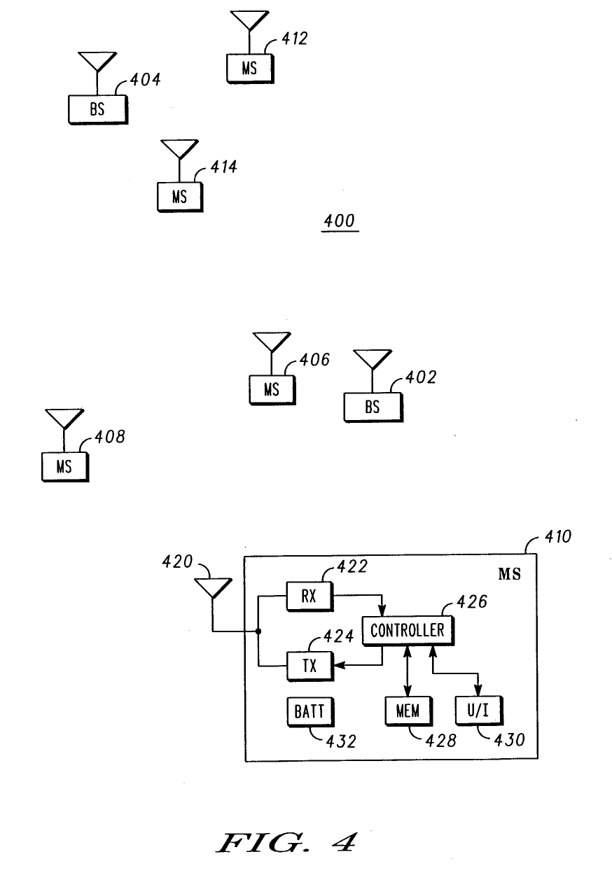

FIG. 4 is a block diagram of a radiotelephone system 400. The radiotelephone system may be any cellular system, personal communications system, trunked radio system or any other type of radio system. In an exemplary embodiment, the radiotelephone system 400 is a Universal Mobile Telecommunications System (UMTS) as specified by the Third Generation Partnership Project.

The radiotelephone system 400 includes a plurality of base stations 402, 404, and a plurality of mobile stations. Each base station 402, 404 provides radio communication service to mobile stations in the geographic vicinity of the base station. Thus, in the embodiment of FIG. 4, base station 402 provides radio communication service to mobile stations 406, 408, 410 and base station 404 provides radio communication service to mobile stations 412, 414. A two-way radio link is established between a mobile station and one or more base stations. As a mobile station enters the area served by the base station, the mobile station registers with the base station, so that the mobile station may be locate for paging. As mobile stations move geographically, radio communication is handed off from base station to base station. The system 400 may further include a mobile switching center for controlling system-level operations such as handoff.

Mobile station 410 illustrates an exemplary embodiment of a mobile station of the system 400. The mobile station 410 may also be referred to as a mobile, portable, handheld, user equipment (UE) or radiotelephone. The mobile station 410 includes an antenna 420, a receiver 422, a transmitter 424, a controller 426, memory 428, user interface 430 and battery 432.

The antenna 420 transforms electromagnetic energy to electrical signals provided to the receiver 422, and transforms electrical signals from the transmitter 422 to electromagnetic energy for transmission to remote radio receivers. The receiver 422 responds to the electrical signals from the antenna 420 to produce detected data for the controller 426. The receiver 422 may include circuits such as filters and demodulators. The transmitter 424 responds to formatted data from the controller to provide the electrical signals to drive the antenna 420. The transmitter 424 may include circuits such as modulators and filter. The antenna 420, the receiver 422 and the transmitter 424 together form a radio communication circuit for two-way radio communication with remote radio devices such as the base station 402.

The controller 426 controls operation of the radiotelephone 410. The controller 426 may be implemented as a processor, microprocessor, digital signal processor (DSP) or any other logic circuit or combination of circuits providing control functions. The controller 426 operates in response to data and program instructions stored in the memory 428. In one mode, the controller 426 controls the radio communication circuit by directing the tuning, activation and deactivation of the circuit. The user interface 430 provides user control of the radiotelephone 410. In typical embodiments, the user interface 430 includes a keypad, a display screen, a microphone and a speaker. The battery 432 provides operating power for the radiotelephone 410.

According to the present invention, therefore, a mobile station in a radiotelephone system can preferentially choose how it will select or reselect a cell in idle mode. The network can control this preferential selection and reselection by setting either the bit to either SERVICE BASED_SELECTION_ALLOWED or SERVICE BASED_SELECTION_NOT ALLOWED. In this way, remote mobile stations can be dropped off of weak cells, but close mobile stations can still be provided GPRS services if their best cell also provides such services.

There has been a need in the art for a mobile station's ability to select a cell on which to camp based on services desired by the mobile station. Previously, mobile stations were limited to camping on cells solely based on signal quality regardless of whether a perfectly acceptable alternative cell provided the desired services. Thus, the present invention provides for the broadcast of a new parameter identifies to a mobile station whether the mobile station can preferentially select or reselect a cell based on the availability of certain services. In addition, the present invention permits the network operators to control and maintain network performance by switching its broadcast parameters between such preferential selection and normal selection based on signal strength. In this manner, the overloading by remote Mobiles Stations of certain service providing cells is avoided access to the services from the cells to close mobile stations Thus, the customer can set his mobile station to preferentially select for services while at the same time, the network can control its network performance.

1. A method for selecting and reselecting a radio cell within a cellular mobile radio network having at least two cells by a mobile station in idle mode, comprising:
detecting by the mobile station a plurality of cells providing services selected from the group consisting of no services, only normal services, only additional services, and all services offered;
receiving and evaluating by the mobile station the network information;
receiving and evaluating by the mobile station in idle mode additional network information;
determining the mobile station's service requirements,
automatically selecting, by the mobile station, the best cell meeting the mobile station's service requirements;
monitoring by the mobile station of the network information for a better cell providing the required services.

2. The method according to claim 1 wherein the cellular mobile radio network is a Global System for Mobile Communications (GSM) network.

3. The method of claim 1 wherein the network information comprises a Cell_Bar Qualify parameter, a Cell_Bar Access parameter, and at least one Additional Services_Supported parameter.

4. The method of claim 3 wherein the Additional Service Supported Parameter comprises a GPRS_Supported Parameter.

5. The method of claim 3 wherein the additional network information comprises a service based selection parameter.

6. The method of claim 5 wherein the service based selection parameter comprises Service Based Selection_Allowed or Service Based Selection_Not Allowed parameter.

7. The method of claim 6 wherein the service based selection parameter comprises GPRS Selection_Allowed or GPRS Selection_Not Allowed.

8. The method of claim 6 wherein the network controls service based selection of a cell by selectively setting the service based selection parameter.

9. The method of claim 6 wherein the mobile station prioritizes cells first on the availability of service based selection and then on normal parameters.

10. A method by which a mobile station in idle mode selects and reselects a cell, comprising
selecting, by the mobile station, the desired service mode;
receiving and evaluating network information;
determining a plurality of cells that permit service based selection;
prioritizing the plurality of cells that permit service based selection on the basis of normal prioritizing standards to identify the best cell;
selecting the best cell;
camping on the best cell;
monitoring network information for a change in priority; and
reselecting the best cell.

11. The method according to claim 10 wherein the network information comprises a Cell_Bar_Qualify parameter and a Cell_Bar Access parameter.

12. The method according to claim 11 wherein the network information further comprises a Service_Supported parameter.

13. The method according to claim 12 wherein the network information further comprises a Service Based Selection_Allowed-Service Based Selection_Not Allowed parameter.

14. The method according to claim 13 wherein the Service Service Based Selection_Allowed-Service Based Selection_Not Allowed parameter comprises GPRS Selection_Allowed-GPRS Selection_Not Allowed.

15. The method according to claim 14 wherein the network controls service based selection.

16. A method for permitting a mobile station to select a cell on the basis of services provided by the cell, the method comprising:
providing a plurality of cells in the network wherein each cell supports services selected from the group consisting of only normal services, only additional services, normal and additional services and no services;
periodically transmitting by the network, network information to a plurality of mobile stations which information is evaluated and received by mobile stations to indicate which services are available;
permitting selection by a mobile station of a cell providing a desired service by transmitting with the network information additional information comprising at least one additional parameter permitting service based selection and reselection.

17. The method of claim 16 wherein the system information comprises a Cell_Bar Qualify parameter, a Cell_Bar Access parameter, and at least one Additional Services parameter and at least one service based selection parameter.

18. The method of claim 17 wherein the additional services are selected from the group consisting of an ability to provide a video call, an ability to provide a data call, an ability to provide a bounded transfer delay, and an ability to provide a specified data throughput.

19. The method of claim 18 wherein the additional services comprise Global Packet Radio Services (GPRS).

20. The method of claim 19 wherein the service based selection parameter comprises GPRS Selection_Allowed and GPRS Selection_Not Allowed.

21. The method of claim 20 wherein the additional parameter comprises GPRS Reselection_Allowed and GPRS Reselection_Not Allowed.

22. The method of claim 21 wherein service based selection is regulated by the network by the service based selection parameter.
